(19) United States
(12) Patent Application Publication
(10) Pub. No.: US 2026/0143265 A1
(43) Pub. Date: May 21, 2026

(54) CHANNEL BANDWIDTH ALLOCATION METHOD TO INCREASE EFFECTIVE ROADM DWDM NETWORK CAPACITY

(71) Applicant: AT&T Intellectual Property I, L.P., Atlanta, GA (US)

(72) Inventor: Guodong Zhang, Manalapan, NJ (US)

(73) Assignee: AT&T Intellectual Property I, L.P., Atlanta, GA (US)

(21) Appl. No.: 18/949,451

(22) Filed: Nov. 15, 2024

(51) Int. Cl. H04Q 11/00; H04J 14/02

(52) U.S. Cl. CPC H04Q 11/0062; H04J 14/021; H04Q 2011/0073

(57) ABSTRACT

Aspects of the subject disclosure may include, for example, channel bandwidth allocation to increase effective reconfigurable optical add-drop multiplexer (ROADM) dense wavelength-division multiplexing (DWDM) network capacity. One or more aspects of the subject disclosure may include a method to allocate channel bandwidth efficiently by eliminating one or more guard bands (thereby increasing the usable ROADM DWDM network bandwidth). Other embodiments are disclosed.

### FIELD OF THE DISCLOSURE

The subject disclosure relates to a channel bandwidth allocation method to increase effective ROADM DWDM network capacity.

### BACKGROUND

Reconfigurable optical add-drop multiplexer (ROADM) dense wavelength-division multiplexing (DWDM) systems are widely deployed in various high capacity. complex and dynamically configured optical networks. FIG. 1A shows an example of a conventional ROADM DWDM system 1000, which has six ROADM nodes (C, D, E, F, G, H). The transmission is bidirectional, for example, one fiber carries the DWDM optical signals from east to west (that is, from right to left in this figure) and another fiber carries the signals for the opposite direction. The ROADMs can typically support 80 or more wavelengths in each direction. In this example, ROADM nodes C, D, F and G are two-degree nodes, ROADM node E is a three-degree node, and ROADM node H a one-degree node. The transponders and regenerators are responsible for transmitting customers' services from one location to another location, and each ROADM node is capable of adding/dropping the wavelength of the transponders (and regenerators).

An important conventional technology of the ROADMs is the wavelength selective switch (WSS) device. The wavelengths from one direction can be routed to one of multiple directions via the WSS at each ROADM site. For example, the wavelengths from the transponders (or regenerators) added (and dropped) at ROADM E can be transmitted (and received) to (and from) the ROADM node C, or D, or F, or G, or H as needed. The multi-degree ROADM nodes also enable the wavelengths to pass-through (or express-through) the node if the wavelengths do not need to be added/dropped. For example, the wavelengths between the ROADM node C and G can express-through the ROADM nodes D, E and F if needed. The in-line optical amplifier (ILA) nodes (shown here as elements 1002, 1003) are used to boost the DWDM signal strength along in the fiber path when the distance between the adjacent ROADM nodes is too long (or the fiber loss is too high), but add extra noise as well to the signals (of note, there can be situations in which an ILA is not required between ROADM nodes).

Referring now to FIG. 1B, this shows a generalized configuration of a wavelength selective switch (WSS). More particularly, this figure shows a 1×N WSS. In operation, when the DWDM input fiber launches the light into free space to a diffractive grating, the grating spatially separates the incoming wavelengths (1, 3, 4, 5, 6 . . . , k, . . . ). Then an optical switching array redirects the individual wavelength toward different output ports as provisioned (e.g., wavelength 3, 4, 5, 6 . . . to output fiber 1, wavelength k, r, . . . to outport fiber 2, and wavelength 1, 1, . . . to output fiber N). The wavelengths of each output fiber can be either multiplexed with other wavelengths to transmit to other directions or dropped at the local node. While this description and the configuration in FIG. 1B represent a WSS as a 1×N switch, the WSS can be designed and operated in reverse direction as a N×1 switch, or even as a M×N switch.

Referring now to both FIGS. 1A and 1B, since the optical amplifier bandwidth is limited, there is a need to multiplex as many wavelengths as possible in order to maximize the transmission capacity. Consequently, the “ideal” WSS with flat top and steep edges of frequency response is desirable in order to pack the wavelengths as close as possible. However, realistic (real-world) WSS transfer functions have non-flat top and limited roll-off rates at the edges. In addition, each WSS has slightly different performance from the others due to variations of manufacture. Accordingly, the transmission could typically be slightly degraded every time the wavelength passes through each WSS, and the WSS filtering effect (and “penalty”) are cumulative as the wavelength travels through multiple WSS in the ROADM DWDM system.

Referring now to FIG. 1C, this shows the WSS filtering effect of 70 Gbaud/s PM-16QAM signal over 75 GHz channel bandwidth in a certain conventional ROADM DWDM system. It is seen that the signal's spectrum is becoming narrower and narrower as it passes through more ROADM nodes (i.e., WSS devices). The spectrum narrowing effect causes transmission penalty for the signal. As shown in Table 1 (which characterizes Q-penalty (dB) of a 70 Gbaud/s PM-16QAM signal over 75 GHz channel bandwidth), the transmission is degraded more and more as it passes through more WSS devices (the signal becomes invalid in this example when it passes 5 WSS devices due to the limited margin for the 880 Km 400G transmission).

TABLE 1

| Number of WSS | Q-penality (dB) |
|---|---|
| 2 | 0.1 |
| 4 | 1.1 |
| 5 | >1.9, no sync |

Referring now to FIG. 1D (showing wavelength allocation with guard bands), it is seen that in order to avoid (or minimize) the WSS filtering effect in a ROADM DWDM system, a conventional approach is to add a guard band to each side of the wavelength slot. For example, a guard band of 6.25 GHz bandwidth is added to each side of the 75 GHz wavelength slot (wherein each wavelength then consumes 87.5 GHz bandwidth). Accordingly, as shown in the example of FIG. 1D, 12.5 GHz bandwidth of each wavelength slot has been wasted (i.e., does not carry traffic).

### BRIEF DESCRIPTION OF THE DRAWINGS

Reference will now be made to the accompanying drawings, which are not necessarily drawn to scale, and wherein:

FIG. 1A is a block diagram that shows an example of a conventional ROADM DWDM system.

FIG. 1B is a block diagram that shows an example of a conventional WSS device.

FIG. 1C shows an example of plots of data related to operation of a conventional WSS device.

FIG. 1D shows an example of conventional use of guard bands.

FIG. 2A shows an embodiment of a ROADM DWDM system in accordance with various aspects described herein.

FIG. 2B shows an embodiment of reduced guard band usage (wherein certain adjacent wavelengths are without intervening guard band) in accordance with various aspects described herein.

FIG. 2C shows an example of plots of data (70 Gbaud/s PM-16QAM spectrum after 5 WSS with guard band vs Tx spectrum) characterizing an embodiment in accordance with various aspects described herein.

FIGS. 3A-3C show embodiments of reduced guard band usage in accordance with various aspects described herein.

FIGS. 4A-4C show (in combination) an embodiment of a flowchart in accordance with various aspects described herein.

FIG. 5A depicts an illustrative embodiment of a method in accordance with various aspects described herein.

FIG. 5B depicts an illustrative embodiment of a method in accordance with various aspects described herein.

FIG. 5C depicts an illustrative embodiment of a method in accordance with various aspects described herein.

### DETAILED DESCRIPTION

The subject disclosure describes, among other things, illustrative embodiments for channel bandwidth allocation to increase effective reconfigurable optical add-drop multiplexer (ROADM) dense wavelength-division multiplexing (DWDM) network capacity. Other embodiments are described in the subject disclosure.

One or more aspects of the subject disclosure include a method to allocate channel bandwidth efficiently by eliminating one or more guard bands (thereby increasing the usable ROADM DWDM network bandwidth).

One or more aspects of the subject disclosure include a method, comprising: storing in a database information related to a reconfigurable optical add-drop multiplexer (ROADM) dense wavelength-division multiplexing (DWDM) system, resulting in stored information, wherein the stored information reserves a plurality of frequency bands, each frequency band of the plurality of frequency bands comprising one or more frequency slots, each frequency band of the plurality of frequency bands corresponding to a particular optical path of a plurality of optical paths in the ROADM DWDM system; receiving a first traffic demand for a first channel (CH1), wherein CH1 has a first one of the plurality of optical paths; assigning a first frequency to CH1 with a first required channel bandwidth, wherein the first frequency corresponds to a particular frequency band of one of the plurality of optical paths, and wherein guard bands are added to both sides of CH1; updating the database with updated information indicative of the assigning of the first frequency to CH1, resulting in stored updated information; receiving a second traffic demand for a second channel (CHx); determining whether CHx has the optical path of CH1, resulting in a first determination; responsive to the first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx, and wherein a guard band is added to a side of CHx that has no adjacent channel; and updating the database with further updated information indicative of the assigning of the second frequency to CHx, resulting in stored further updated information.

One or more aspects of the subject disclosure include a method, comprising: storing in a database information related to a reconfigurable optical add-drop multiplexer (ROADM) dense wavelength-division multiplexing (DWDM) system, resulting in stored information, wherein the stored information reserves a plurality of frequency bands, wherein each frequency band of the plurality of frequency bands comprises one or more frequency slots, wherein each frequency band of the plurality of frequency bands corresponds to a particular optical path of a plurality of optical paths in the ROADM DWDM system, wherein the stored information is indicative of an assigning of a first frequency to a first channel (CH1) that has a first one of the plurality of optical paths, wherein CH1 has a first required channel bandwidth, wherein the first frequency corresponds to a particular frequency band of one of the plurality of optical paths, and wherein guard bands had been added to both sides of CH1; receiving a traffic demand for a second channel (CHx); responsive to a first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx; updating the database with updated information indicative of the assigning of the second frequency to CHx, resulting in stored updated information; receiving another traffic demand for a third channel (CHy); responsive to a second determination being that CHy has the optical path of CH1, assigning a third frequency to CHy with a third required channel bandwidth, wherein the third frequency corresponds to the particular frequency band of the optical path of CH1, wherein another guard band associated with CH1 that would have otherwise been between CH1 and CHy is removed and the bandwidth is instead used by CHy; and updating the database with further updated information indicative of the assigning of the third frequency to CHy, resulting in stored further updated information.

One or more aspects of the subject disclosure include a method, comprising: storing in a database information related to a reconfigurable optical add-drop multiplexer (ROADM) dense wavelength-division multiplexing (DWDM) system, resulting in stored information, wherein the stored information reserves a plurality of frequency bands, wherein each frequency band of the plurality of frequency bands comprises one or more frequency slots, wherein each frequency band of the plurality of frequency bands corresponds to a particular optical path of a plurality of optical paths in the ROADM DWDM system, wherein the stored information is indicative of an assigning of a first frequency to a first channel (CH1) that has a first one of the plurality of optical paths, wherein CH1 has a first required channel bandwidth, wherein the first frequency corresponds to a particular frequency band of one of the plurality of optical paths, and wherein guard bands had been added to both sides of CH1; receiving a traffic demand for a second channel (CHx); responsive to a first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx; updating the database with updated information indicative of the assigning of the second frequency to CHx, resulting in stored updated information; receiving another traffic demand for a third channel (CHy); responsive to a second determination being that CHy does not have the optical path of CH1, assigning a third frequency to CHy with a third required channel bandwidth, wherein the third frequency corresponds to another frequency band that is not part of the optical path of CH1, and wherein a guard band is added to each side of CHy that has no adjacent channel; and updating the database with additional updated information indicative of the assigning of the third frequency to CHy, resulting in stored additional updated information.

As described herein, various embodiments provide a method to allocate channel bandwidth efficiently (via elimination of one or more guard bands) and to thus increase the effective ROADM DWDM network bandwidth. In various embodiments, an algorithm can implement the following: 1) For transmissions that share the same optical path, provision the channels to have the wavelengths adjacent to each other without guard bands between them. 2) For transmissions with different optical paths, arrange the wavelengths for the channels as adjacent to each other without intervening guard bands in such a way that their paths differ only slightly and they overlap as many ROADM nodes as possible. 3) For a wavelength without an adjacent one, guard bands will be allocated in order to minimize the WSS filtering penalty. Further, when a potential adjacent wavelength becomes available, provision the adjacent wavelength without an intervening guard band and remove any intervening guard band of the previous wavelength.

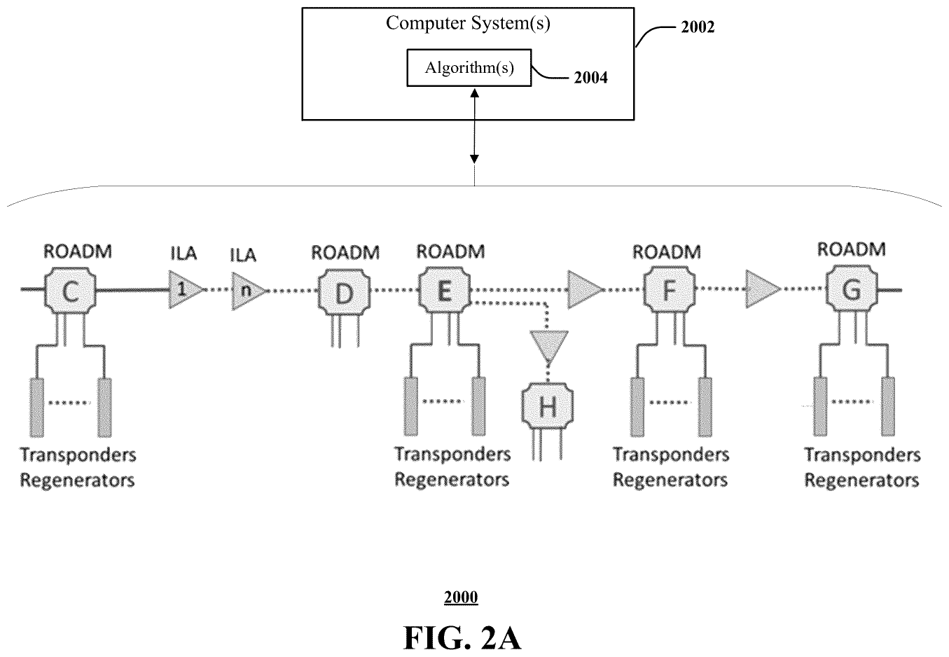

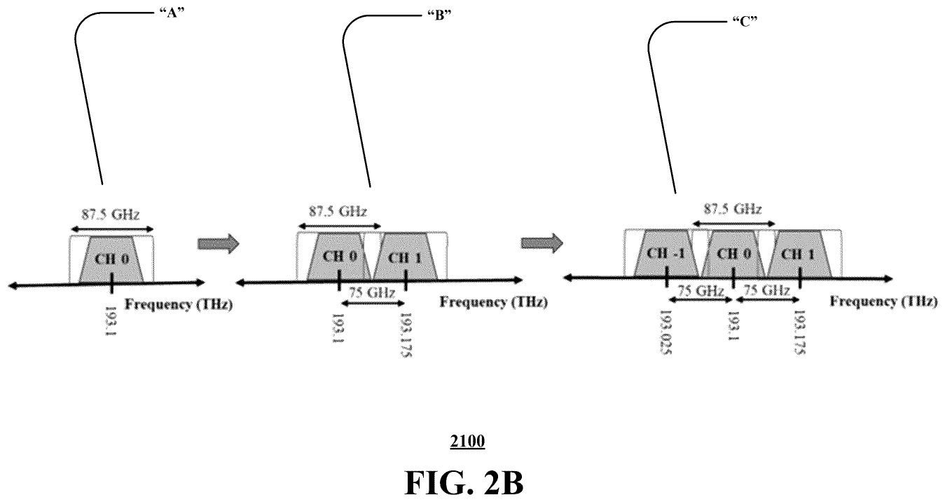

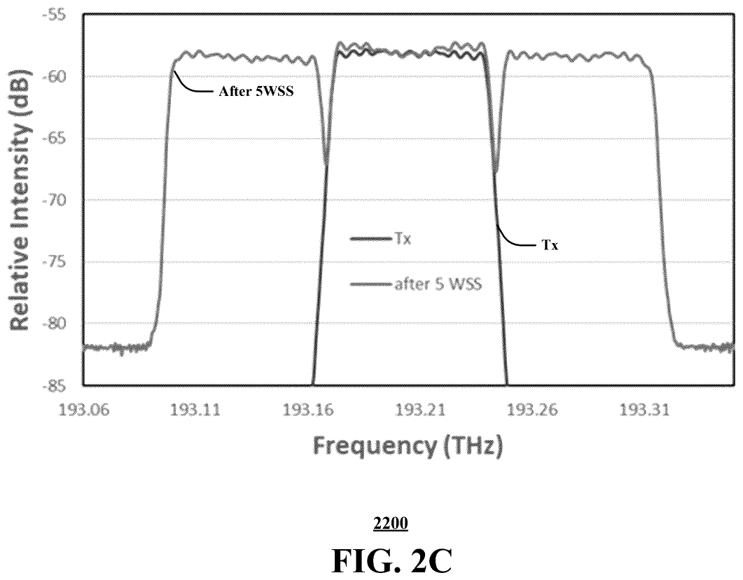

Referring now to FIG. 2A, this shows an embodiment of a ROADM DWDM system 2000 in accordance with various aspects described herein. As seen in this figure, the system 2000 includes computer system(s) 2002, upon which algorithm(s) 2004 operate. In various embodiments, the algorithm(s) 2004 can comprise software that is operative on computer system(s) 2002 (such computer system(s) can be cloud-based, can be stand-alone computer(s), can be server(s), or any combination thereof). In various embodiments, the algorithm(s) 2004 can function to provide channel bandwidth allocation as described herein (e.g., allocation/guard band usage for various channels, wavelengths, etc.).

Reference will now be made to an example of channel allocation according to an embodiment (wherein a number of guard bands can be eliminated without WSS filtering penalty). In this example, there will be three customers' services for 400G transmitting between ROADM C and G, expressing through ROADM D, E and F (see FIG. 2A), and 70 Gbaud/s PM-16QAM modulation is required to ensure the error-free transmission. For the first channel (CH 0), its center wavelength is provisioned at 193.1 THz, and a channel bandwidth of 75 GHz is needed to cover its entire spectrum for this modulation. Since (at this point in time) there is no adjacent wavelength to this channel, a guard band of 6.25 GHz needs to be allocated on each side of the channel in order to eliminate the WSS filtering penalty. Thus, the total bandwidth for this channel (at this point in time) is 87.5 GHz as shown in the left-most portion (see “A”) in FIG. 2B.

As the 2^{nd} service (CH 1) request (in this example) is also between ROADM C and G (similar to CH 0), the CH 1 wavelength can be placed on the left or on the right side of CH 0 (in this example, its center wavelength is provisioned at 193.175 THz and guard band is eliminated on the right side of CH 0 (but a guard band of 6.25 GHz is allocated on the right side of CH 1 in order to reduce the WSS filtering penalty). It is seen (as shown in the center portion (see “B”) in FIG. 2B) that there is no guard band between the CH 0 and CH 1 and the wavelength space between them is 75 GHz rather than the usual 87.5 GHZ.

Further, as the 3^{rd} service (CH-1) between ROADM C and G is requested, its wavelength can be placed on the left side of CH 0 or on the right side of CH 1 (in this example, its center wavelength is provisioned at 193.025 THz and the guard band is eliminated on the left side of CH 0 (but a guard band of 6.25 GHz is allocated on the left side of CH-1 in order to reduce the WSS filtering penalty). It is seen (as shown in the right-most portion (see “C”) in FIG. 2B) that there is no guard band between the CH 0 and CH-1 and the wavelength space between them is 75 GHz rather than the usual 87.5 GHz.

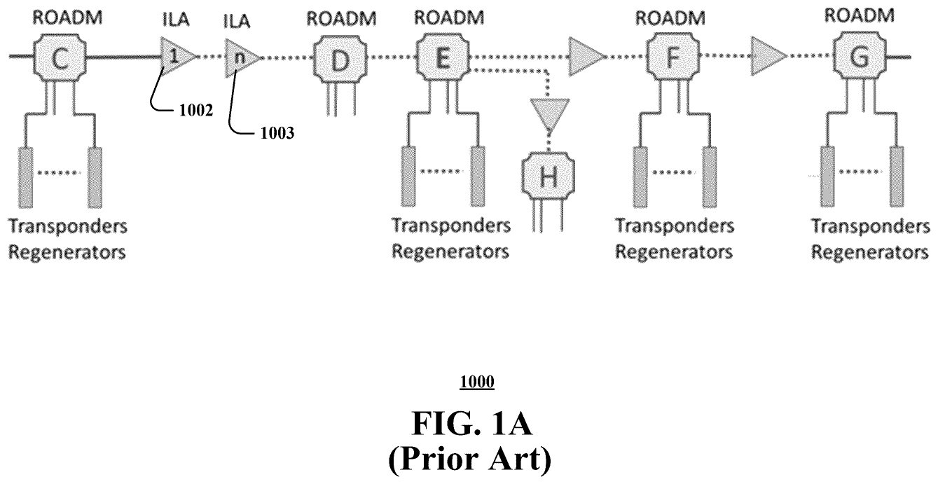

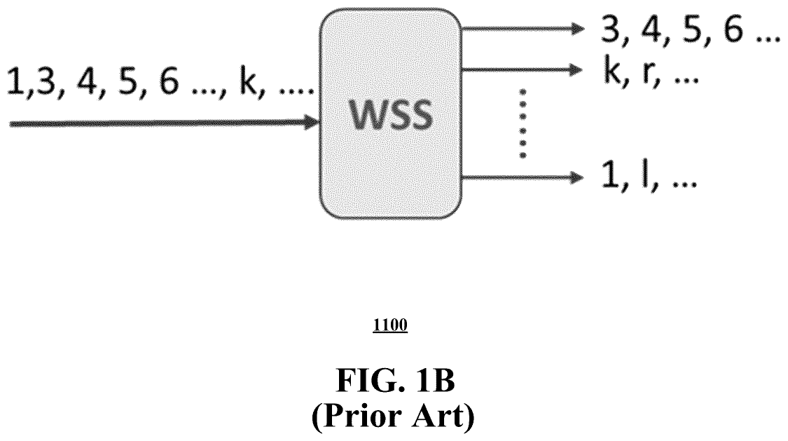

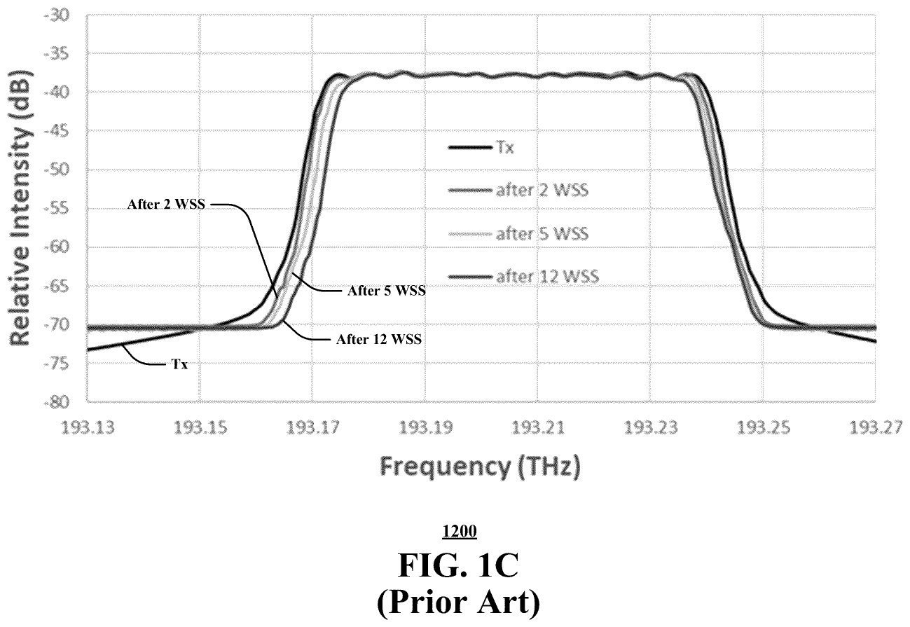

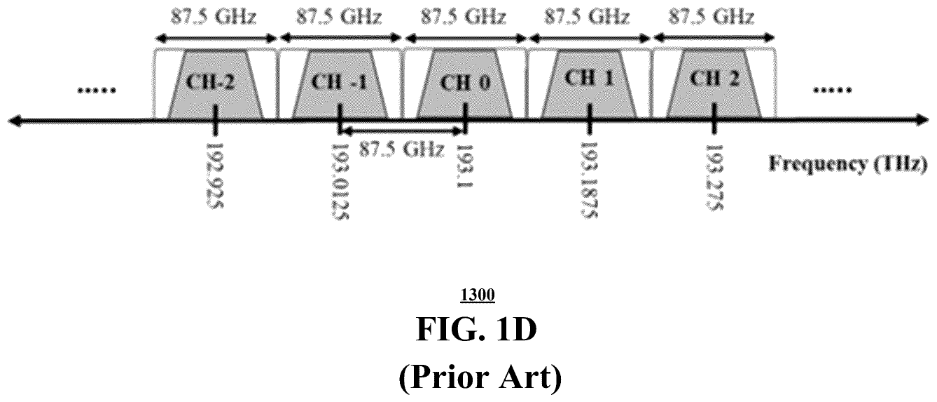

As described herein, various embodiments can operate in the context of a conventional flex-grid WSS device. In such embodiments, if the adjacent wavelengths share the same input fiber port and the same output fiber port, these wavelengths would not experience WSS filtering effect (without guard bands) since these wavelengths are bonded together without separation in the entire optical path within the WSS. For example, the adjacent wavelengths 3, 4, 5 and 6 in FIG. 1B are incoming from the same input fiber port (on the left) and switched and output at the same output fiber port (on the right). Wavelengths 4 and 5 would not experience any WSS filtering effect without guard bands, but wavelengths 3 and 6 will have “half” WSS filtering effect without guard bands (since the adjacent wavelength 2 and 7, respectively, are not present).

Referring now to FIG. 2C, this shows results of an experiment related to certain aspects of an embodiment. As seen in this figure, three 400G channels were provisioned and transmitted as adjacent wavelengths without guard band over 5 WSS ROADM link with 880 Km SMF fiber path, 70 Gbaud/s PM-16QAM modulation scheme, and 75 GHz channel space applied. As seen in graph 2200, the spectrum of the channel in the middle after transmitting over 5 WSS is almost overlapping with its transmitter spectrum (there is essentially no WSS filtering effect observed), in particular, its spectrum edges are exactly overlapping with those of its transmitter spectrum. No WSS filtering penalty was observed for the channel in comparison of more than 1.9 dB Q-penalty in Table 1. There was, however, about 0.4 dB Q-penalty due to cross-talking with its adjacent channels which also occurred for the case with the guard band implementation (about 0.2 dB Q-penalty).

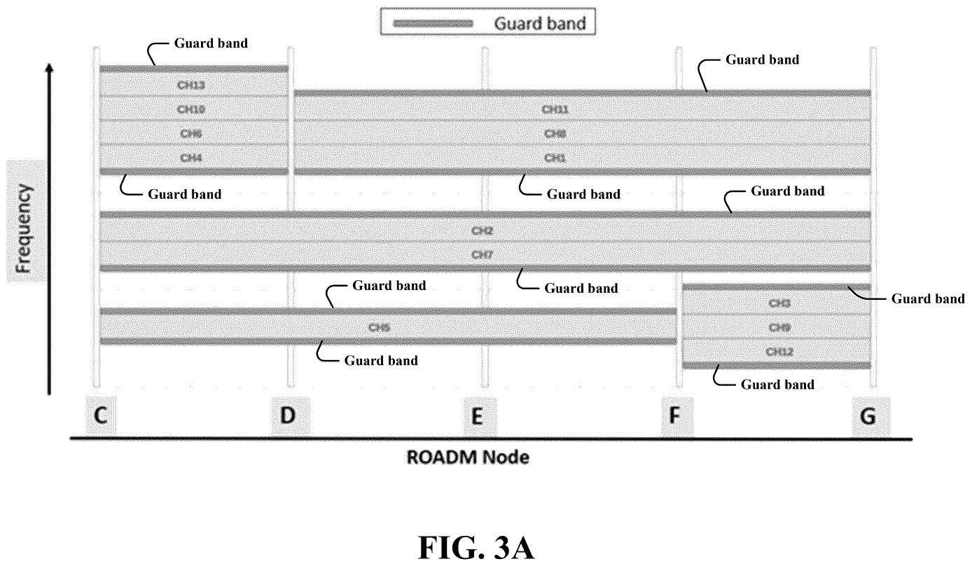

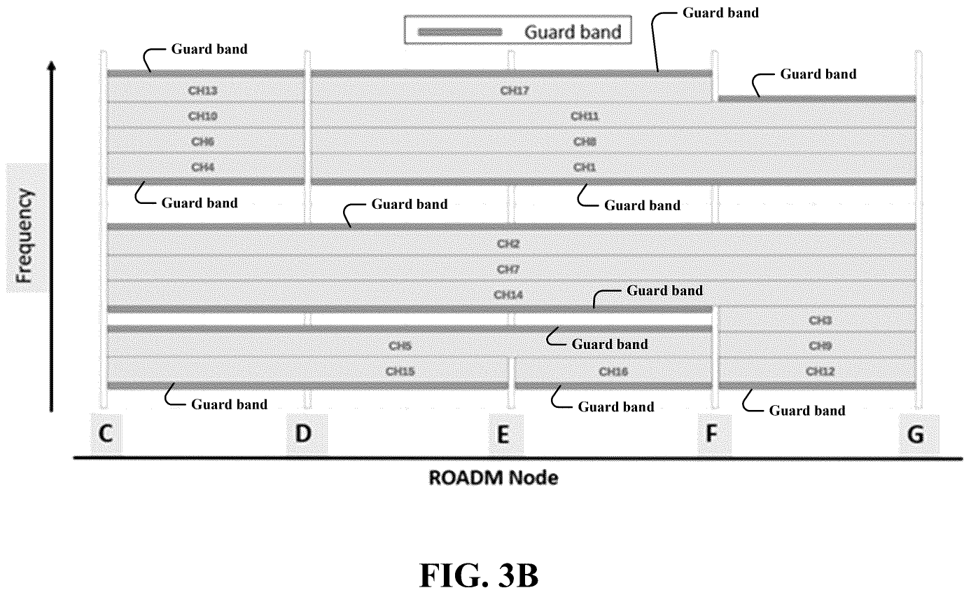

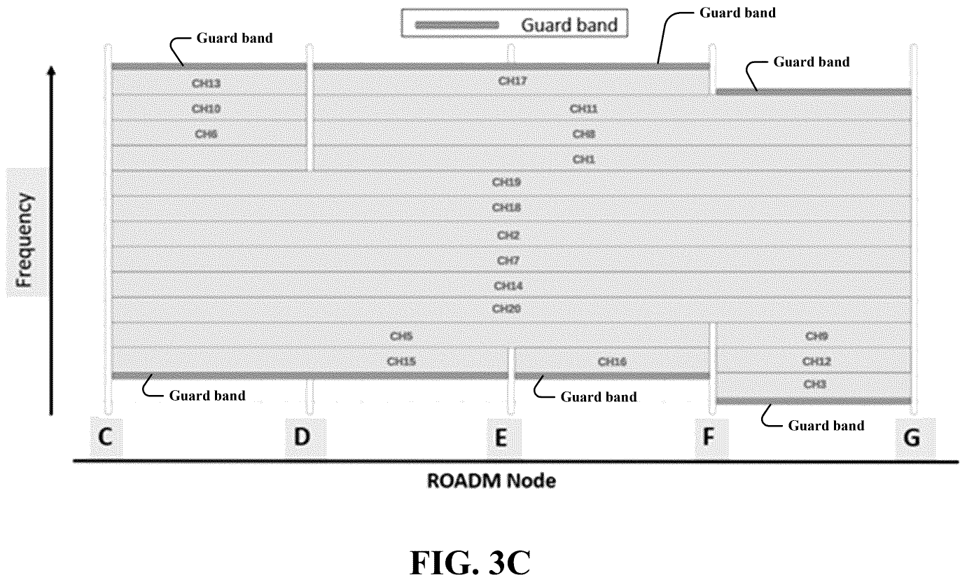

Referring now to FIGS. 3A-3C, these show embodiments related to channel bandwidth allocations for channels having different optical paths. In these examples, the channels of CH1, CH2, CH3, . . . . CH20 are numbered in time sequence when the service demands are planned. As shown in FIG. 3A (for the cases when there are a few channels—i.e., in the beginning of adding traffic to the ROADM DWDM network), the channels having the same optical path were placed adjacent to each other in frequency without guard band between them, but there is always a guard band for the channels when there is no adjacent channel. It is clearly seen that there is no WSS filtering effect for any of the channels (CH1 to CH13). Of note, the strategy and benefit of such an approach were discussed, for example, in connection with FIG. 2B.

Still referring to FIGS. 3A-3C, it is noted that intuitively there is a need of some knowledge base to decide which frequencies to assign to the grouping of channels for different optical paths. Such knowledge (according to various embodiments) can include traffic history, anticipation of future traffic demand, optical-signal-to-noise ratio (OSNR) of each optical path, etc. For example, in a case of the OSNR having the highest value in middle band of spectrum, it is favorable to assign the frequencies to the channels transmitting the longest path (if the transponders have enough Q-margin). In FIG. 3A, the CH2 and CH7 have the longest path and were assigned with frequencies in the middle of spectrum.

Referring now to FIG. 3B, this figure shows the need to add more channels as more traffic demand arrives. First, CH14 between Node C and G is added. Since it has the same optical path as CH2 and CH7, it can be assigned an available frequency adjacent to CH7. Both CH3 and CH14 experience “half” WSS filtering effect at Node 5 where they transmit over different optical paths. Secondly, CH15 between Node C and E and CH16 between Node E and F are added, and are assigned to a frequency adjacent and below existing CH5 between Node C and F. The basic strategy for such frequency assignments of CH15 and CH16 is to assure to overlap WSS as many as possible for the adjacent channels with different optical transmission paths (then, minimize the WSS filtering effect as much as possible). In this case, the CH5, CH15 and CH16 only experience “half” WSS filtering effect at Node E. To verify the benefits of this frequency assignment for CH15 and CH16, a comparison can be made of this assignment to another non-favorable assignment of their frequency adjacent to (and below) CH4 and CH1. Then CH4 will endure one “half” WSS filtering effect at Node D; CH1 will have three “half” WSS filtering effect at Node D, E, and F; CH15 will suffer two “half” WSS filtering effect at Node D and E; and CH16 will be penalized by two “half” WSS filtering effects at Node E and F. It can be seen that this non-favorable frequency assignment causes much more WSS filtering effects than the assignment in FIG. 3B (according to various embodiments) for the new channels CH15 and CH16 and the existing channels.

Furthermore, as another new service, CH17, between Node D and F is requested, one of the favorable options is to assign its frequency adjacent to CH11. Then CH11 and CH17 will only suffer “half” WSS filtering penalty.

Reference will now be made to certain details of how to manage (according to various embodiments) the guard band and WSS provisioning when adjacent channel is added with different optical transmission path. When CH15 and CH16 are added adjacent to CH5 in FIG. 3B, the previous lower guard band of CH5 (see, also, for example, FIG. 2B) automatically becomes part of channel bandwidth for CH15 between Node C and E, and for CH16 between Node E and F. The optical transmission separating point between CH5 and CH15 is at Node E, the extra opening of WSS for the lower guard band of CH5 needs to be removed by the controller of ROADM Node E and be steered to be used for the channel bandwidth of the added CH15. But the extra opening of WSS of the lower guard band at Node C and D will stay and automatically becomes part of bandwidth of CH15. Similarly, the provisioning of the WSS at Node E and F when adding adjacent CH16 will follow the same approach as that of adding CH15. This is the reason that CH5, CH15 and CH16 suffer “half” WSS filtering effect penalty. On the other hand, there is no adjacent channel in lower frequency direction for CH15 and CH16, then a guard band is added for them (according to various embodiments) to eliminate the WSS filtering effect.

As more channels are added to the ROADM DWDM network and more spectrums are occupied, there could be some use cases that there is not available adjacent frequency slot for a new channel which has same optical transmission path as the existing channels. However, a new frequency can be re-assigned (according to various embodiments) to the adjacent channel having different optical path to free up the adjacent frequency slot. For example, it may be required to add three channels between Node C and G, which have the same path as CH2 and CH7. First, CH18 and CH19 can be assigned with the available frequency slots above CH2 as shown in FIG. 3C, but there is not an available frequency slot for the third channel as in FIG. 3B. On the other hand, if CH3 can be relocated to another frequency, the adjacent frequency slot will be available for the third channel. As shown in FIG. 3C, the frequency for CH3 can be re-assigned below CH12 and as adjacent channel to it. Then the third channel, CH20 can be added as an adjacent channel below CH14.

Overall, it can be seen from FIG. 3C that the channel bandwidth allocation method (according to various embodiments) can enable elimination of guard bands between adjacent channels, thus increasing effective transmission capacity of the ROADM DWDM network, and resulting in minimum WSS filtering penalty (e.g., only a few channels experienced “half” WSS filtering effect).

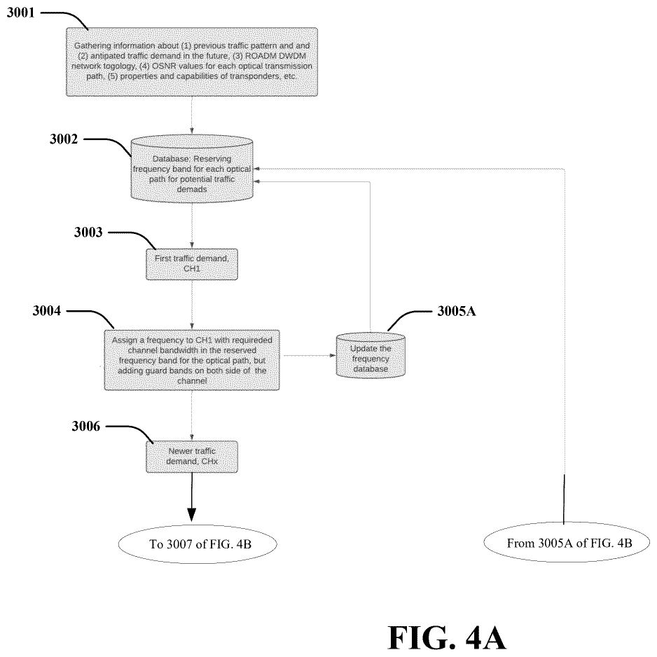

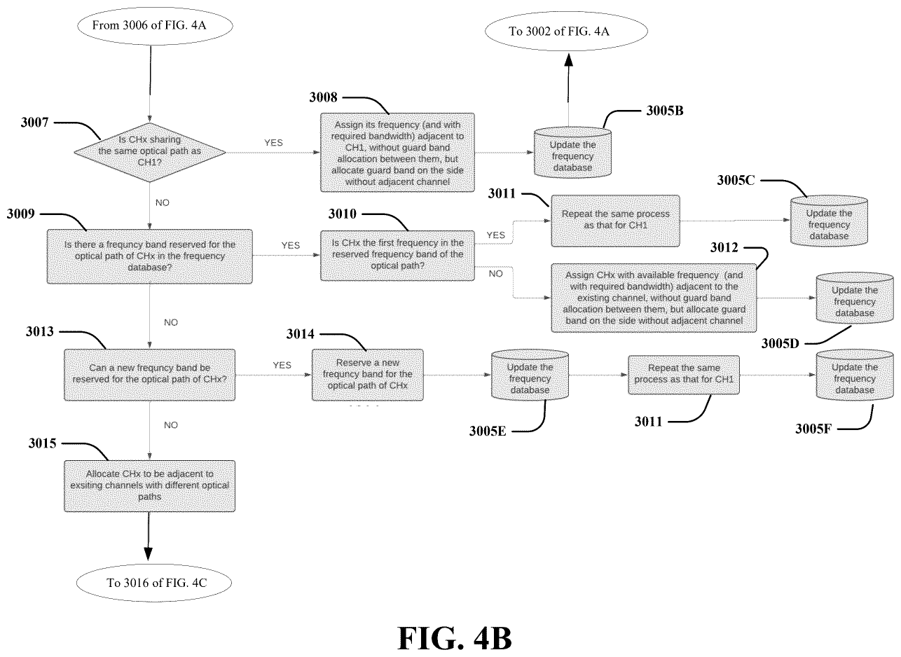

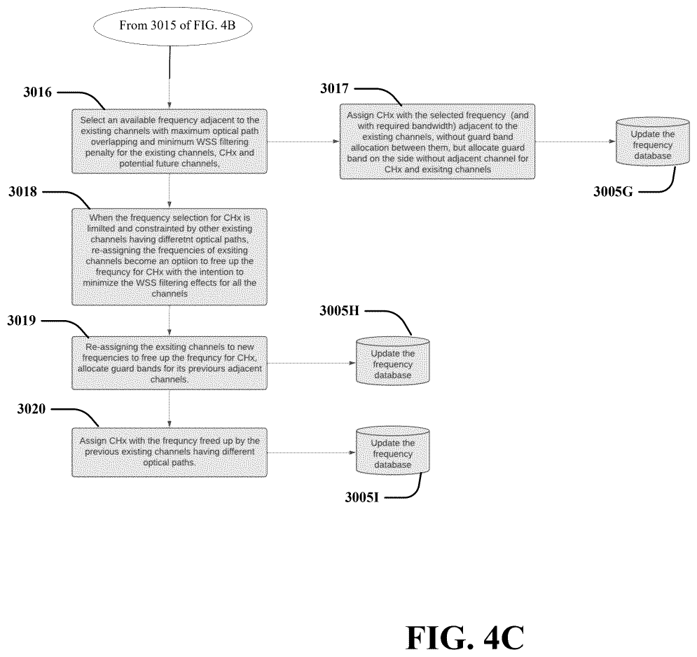

Referring now to FIGS. 4A-4C, these show (in combination) an embodiment of a flowchart in accordance with various aspects described herein. More particularly, as seen, the process proceeds from step 3001, to 3002, to 3003, to 3004. From step 3004, the process feeds back to step 3003 (via step 3005A) and also proceeds to step 3006. From step 3006, the process proceeds to step 3007 (of FIG. 4B). Further, from step of 3007, in a case that the decision answer is “YES”, the process proceeds to step 3008, to step 3005B, and back to step 3002 (of FIG. 4A). On the other hand, from step 3007, in a case that the decision answer is “NO”, the process proceeds to step 3009. Further, from step 3009, in a case that the decision answer is “YES”, the process proceeds to step 3010 (then in a case of “YES” to step 3011 and step 3005C; or, in a case of “NO” to step 3012 and step 3005D. On the other hand, from step 3009, in a case that the decision answer is “NO”, the process proceeds to step 3013. Further, from step of 3013, in a case that the decision answer is “YES”, the process proceeds to step 3014, to step 3005E, to step 3011, and to step 3005F. On the other hand, from step 3013, in a case that the decision answer is “NO”, the process proceeds to step 3015. From step 3015, the process proceeds to step 3016 (of FIG. 4C). Further, from step 3016, the process proceeds to step 3017 and to step 3005G. In the alternative, the process can proceed to step 3018, to step 3019 and to step 3005H. In addition, from step 3019, the process can proceed to step 3020 and to step 3005I.

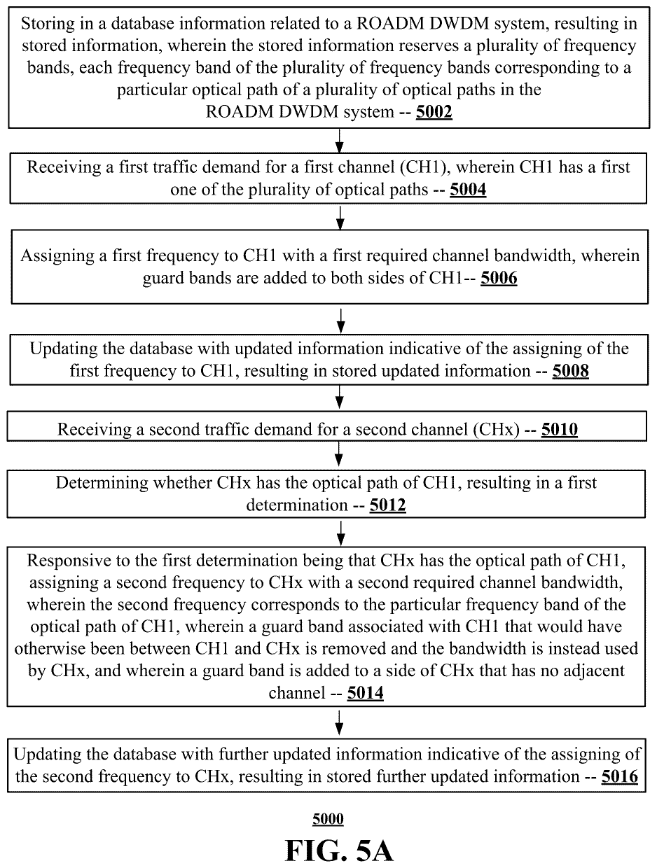

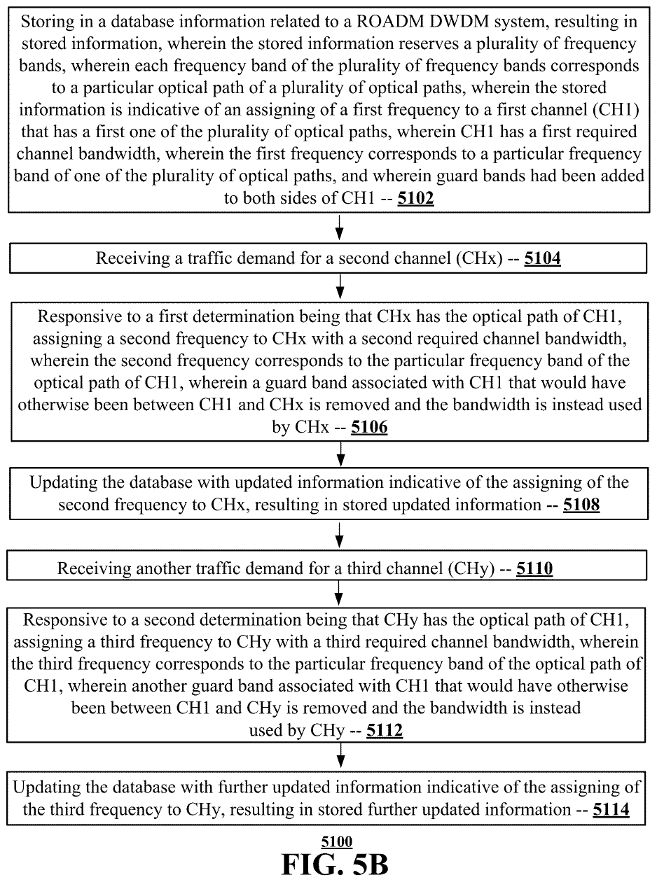

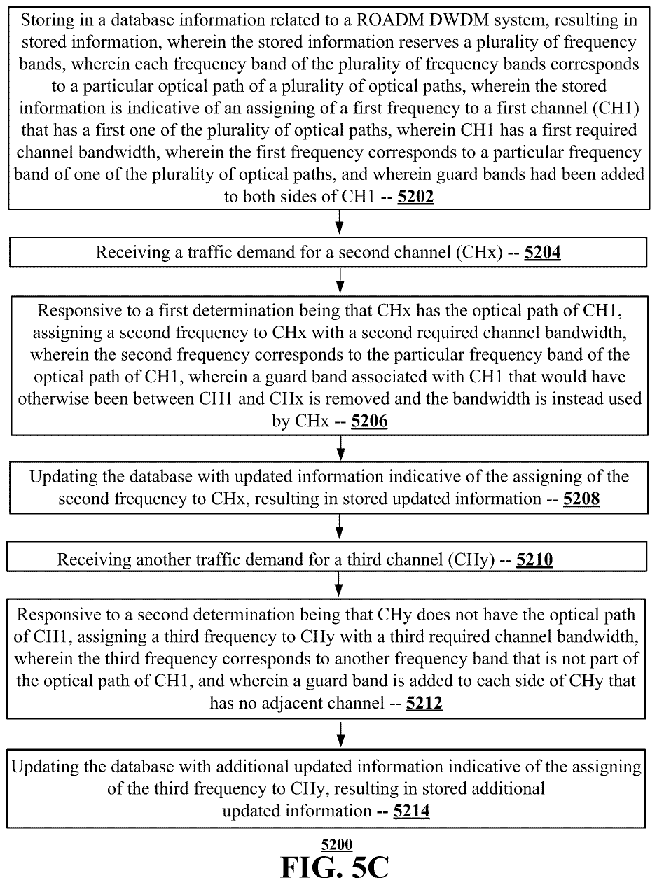

Referring now to FIG. 5A, various steps of a method 5000 according to an embodiment are shown. As seen in this FIG. 5A, step 5002 comprises storing in a database information related to a reconfigurable optical add-drop multiplexer (ROADM) dense wavelength-division multiplexing (DWDM) system, resulting in stored information, wherein the stored information reserves a plurality of frequency bands, each frequency band of the plurality of frequency bands comprising one or more frequency slots, each frequency band of the plurality of frequency bands corresponding to a particular optical path of a plurality of optical paths in the ROADM DWDM system. Next, step 5004 comprises receiving a first traffic demand for a first channel (CH1), wherein CH1 has a first one of the plurality of optical paths. Next, step 5006 comprises assigning a first frequency to CH1 with a first required channel bandwidth, wherein the first frequency corresponds to a particular frequency band of one of the plurality of optical paths, and wherein guard bands are added to both sides of CH1. Next, step 5008 comprises updating the database with updated information indicative of the assigning of the first frequency to CH1, resulting in stored updated information. Next, step 5010 comprises receiving a second traffic demand for a second channel (CHx). Next, step 5012 comprises determining whether CHx has the optical path of CH1, resulting in a first determination. Next, step 5014 comprises responsive to the first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx, and wherein a guard band is added to a side of CHx that has no adjacent channel. Next, step 5016 comprises updating the database with further updated information indicative of the assigning of the second frequency to CHx, resulting in stored further updated information.

While for purposes of simplicity of explanation, the respective processes are shown and described as a series of blocks in FIG. 5A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 5B, various steps of a method 5100 according to an embodiment are shown. As seen in this FIG. 5B, step 5102 comprises storing in a database information related to a reconfigurable optical add-drop multiplexer (ROADM) dense wavelength-division multiplexing (DWDM) system, resulting in stored information, wherein the stored information reserves a plurality of frequency bands, wherein each frequency band of the plurality of frequency bands comprises one or more frequency slots, wherein each frequency band of the plurality of frequency bands corresponds to a particular optical path of a plurality of optical paths in the ROADM DWDM system, wherein the stored information is indicative of an assigning of a first frequency to a first channel (CH1) that has a first one of the plurality of optical paths, wherein CH1 has a first required channel bandwidth, wherein the first frequency corresponds to a particular frequency band of one of the plurality of optical paths, and wherein guard bands had been added to both sides of CH1. Next, step 5104 comprises receiving a traffic demand for a second channel (CHx). Next, step 5106 comprises responsive to a first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx. Next, step 5108 comprises updating the database with updated information indicative of the assigning of the second frequency to CHx, resulting in stored updated information. Next, step 5110 comprises receiving another traffic demand for a third channel (CHy). Next, step 5112 comprises responsive to a second determination being that CHy has the optical path of CH1, assigning a third frequency to CHy with a third required channel bandwidth, wherein the third frequency corresponds to the particular frequency band of the optical path of CH1, wherein another guard band associated with CH1 that would have otherwise been between CH1 and CHy is removed and the bandwidth is instead used by CHy. Next, step 5114 comprises updating the database with further updated information indicative of the assigning of the third frequency to CHy, resulting in stored further updated information.

While for purposes of simplicity of explanation, the respective processes are shown and described as a series of blocks in FIG. 5B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 5C, various steps of a method 5200 according to an embodiment are shown. As seen in this FIG. 5C, step 5202 comprises storing in a database information related to a reconfigurable optical add-drop multiplexer (ROADM) dense wavelength-division multiplexing (DWDM) system, resulting in stored information, wherein the stored information reserves a plurality of frequency bands, wherein each frequency band of the plurality of frequency bands comprises one or more frequency slots, wherein each frequency band of the plurality of frequency bands corresponds to a particular optical path of a plurality of optical paths in the ROADM DWDM system, wherein the stored information is indicative of an assigning of a first frequency to a first channel (CH1) that has a first one of the plurality of optical paths, wherein CH1 has a first required channel bandwidth, wherein the first frequency corresponds to a particular frequency band of one of the plurality of optical paths, and wherein guard bands had been added to both sides of CH1. Next, step 5204 comprises receiving a traffic demand for a second channel (CHx). Next, step 5206 comprises responsive to a first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx. Next, step 5208 comprises updating the database with updated information indicative of the assigning of the second frequency to CHx, resulting in stored updated information. Next, step 5210 comprises receiving another traffic demand for a third channel (CHy). Next, step 5212 comprises responsive to a second determination being that CHy does not have the optical path of CH1, assigning a third frequency to CHy with a third required channel bandwidth, wherein the third frequency corresponds to another frequency band that is not part of the optical path of CH1, and wherein a guard band is added to each side of CHy that has no adjacent channel. Next, step 5214 comprises updating the database with additional updated information indicative of the assigning of the third frequency to CHy, resulting in stored additional updated information.

While for purposes of simplicity of explanation, the respective processes are shown and described as a series of blocks in FIG. 5C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Of note, various example channel arrangements described herein (e.g., as shown in certain figures) are intended to be illustrative and not restrictive. Such channel arrangements can have any desired channel above or below any other desired channel (e.g., CHy-CH1-CHx or CHx-CH1-CHy or CH1-CHx-CHy or CHy-CHx-CH1).

As described herein, various embodiments can provide a channel bandwidth allocation method to increase ROADM DWDM effective network capacity (e.g., by reducing guard band usage).

As described herein, various embodiments can eliminate certain conventional guard bands by selective allocation of channels in a ROADM DWDM network (such elimination of guard bands (which do not carry traffic) reduces waste of parts of the fiber transmission bandwidth).

As described herein, various embodiments can provide mechanisms to increase the usable transmission bandwidth of ROADM DWDM networks without adding or changing hardware. For example, certain conventional ROADM DWDM systems allocate 87.5 GHz bandwidth for 400G channels with guard bands. Via use of various embodiments, the channel bandwidth can be reduced to 75 GHz or less for the 400G channels (consequently, in this example, the total usable capacity can be increased by 11.67%).

As described herein, various embodiments can assign the frequencies for all the channels without guard bands (between adjacent frequencies) in order to increase the effective network transmission capacity. In various embodiments, a method can allocate guard bands temporarily for any channel without adjacent channels along its optical transmission path (e.g., in order to minimize the WSS penalty). As adjacent channel(s) are added, the guard band(s) can automatically become part of the bandwidth of each adjacent channel.

As described herein, various embodiments can provide an iterative process (e.g., adding one or more channels, removing one or more channels, or any combination thereof).

As described herein, various embodiments can provide for storage of data in a database (as well as updating of the data in the database as one or more channels are added and/or one or more channels are removed).

As described herein, various embodiments can provide an algorithm for selecting which wavelength(s) have a guard band (and on which side-upper, lower, or both) and which wavelength(s) do not have a guard band (and on which side-upper, lower, or both). In one example, all (or almost all) guard bands in a system can be eliminated.

As described herein, various embodiments can be implemented via computer-executable instructions that can run on one or more computers, and/or in combination with other program modules and/or as a combination of hardware and software.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
storing in a database information related to a reconfigurable optical add-drop multiplexer (ROADM) dense wavelength-division multiplexing (DWDM) system, resulting in stored information, wherein the stored information reserves a plurality of frequency bands, each frequency band of the plurality of frequency bands comprising one or more frequency slots, each frequency band of the plurality of frequency bands corresponding to a particular optical path of a plurality of optical paths in the ROADM DWDM system;
receiving a first traffic demand for a first channel (CH1), wherein CH1 has a first one of the plurality of optical paths;
assigning a first frequency to CH1 with a first required channel bandwidth, wherein the first frequency corresponds to a particular frequency band of one of the plurality of optical paths, and wherein guard bands are added to both sides of CH1;
updating the database with updated information indicative of the assigning of the first frequency to CH1, resulting in stored updated information;
receiving a second traffic demand for a second channel (CHx);
determining whether CHx has the optical path of CH1, resulting in a first determination;
responsive to the first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx, and wherein a guard band is added to a side of CHx that has no adjacent channel; and
updating the database with further updated information indicative of the assigning of the second frequency to CHx, resulting in stored further updated information.

2. The method of claim 1, further comprising:
receiving a third traffic demand for a third channel (CHy);
determining whether CHy has the optical path of CH1 and CHx, resulting in a second determination;
responsive to the second determination being that CHy has the optical path of CH1 and CHx, assigning a third frequency to CHy with a third required channel bandwidth, wherein the third frequency corresponds to the particular frequency band of the optical path of CH1 and CHx, wherein a guard band associated with one of CH1 or CHx that would have otherwise been between CH1 or CHx and CHy is removed and the bandwidth is instead used by CHy, and wherein a guard band is added to a side of CHy that has no adjacent channel; and
updating the database with additional updated information indicative of the assigning of the third frequency to CHy, resulting in stored additional updated information.

3. The method of claim 1, wherein:
responsive to the first determination being that CHx does not have the optical path of CH1, assigning a second frequency to CHx with a second required channel bandwidth, wherein the second frequency corresponds to another frequency band that is not part of the optical path of CH1, and wherein a guard band is added to each side of CHx that has no adjacent channel; and
updating the database with additional updated information indicative of the assigning of the second frequency to CHx, resulting in stored additional updated information.

4. The method of claim 3, wherein a single guard band is added to only one side of CHx.

5. The method of claim 3, wherein one guard band is added to a first side of CHx and another guard band is added to a second side of CHx.

6. The method of claim 1, further comprising storing in the database additional information related to a previous traffic pattern, an anticipated demand in the future, a network topology of the ROADM DWDM system, an optical-signal-to-noise ratio (OSNR) of each optical path, a respective property of one or more transponders, a respective capability of one or more transponders, or any combination thereof.

7. The method of claim 6, wherein the assigning of the first frequency, the assigning of the second frequency, an assigning of one or more other frequencies, or any combination thereof is based upon the additional information.

8. The method of claim 1, wherein each frequency slot corresponds to a respective channel.

9. The method of claim 1, wherein each of the storing, the receiving the first traffic demand, the assigning the first frequency, the updating the database with updated information, the receiving the second traffic demand, the determining, the assigning the second frequency, and the updating the database with further updated information is performed by a processing system comprising a processor.

10. The method of claim 1, further comprising:
facilitating transmission of first data via the first channel; and
facilitating transmission of second data via the second channel.

11. The method of claim 10, further comprising:
retrieving the stored updated information from the database; and
retrieving the stored further updated information from the database;
wherein the transmission of first data via the first channel is based upon the stored updated information that is retrieved; and
wherein the transmission of second data via the second channel is based upon the stored further updated information that is retrieved.

12. The method of claim 10, wherein:
the transmission of the first data via the first channel comprises the first channel being carried by a wavelength selective switch (WSS); and
the transmission of the second data via the second channel comprises the second channel being carried by the WSS.

13. A method, comprising:
storing in a database information related to a reconfigurable optical add-drop multiplexer (ROADM) dense wavelength-division multiplexing (DWDM) system, resulting in stored information, wherein the stored information reserves a plurality of frequency bands, wherein each frequency band of the plurality of frequency bands comprises one or more frequency slots, wherein each frequency band of the plurality of frequency bands corresponds to a particular optical path of a plurality of optical paths in the ROADM DWDM system, wherein the stored information is indicative of an assigning of a first frequency to a first channel (CH1) that has a first one of the plurality of optical paths, wherein CH1 has a first required channel bandwidth, wherein the first frequency corresponds to a particular frequency band of one of the plurality of optical paths, and wherein guard bands had been added to both sides of CH1;
receiving a traffic demand for a second channel (CHx);
responsive to a first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx;
updating the database with updated information indicative of the assigning of the second frequency to CHx, resulting in stored updated information;
receiving another traffic demand for a third channel (CHy);
responsive to a second determination being that CHy has the optical path of CH1, assigning a third frequency to CHy with a third required channel bandwidth, wherein the third frequency corresponds to the particular frequency band of the optical path of CH1, wherein another guard band associated with CH1 that would have otherwise been between CH1 and CHy is removed and the bandwidth is instead used by CHy; and
updating the database with further updated information indicative of the assigning of the third frequency to CHy, resulting in stored further updated information.

14. The method of claim 13, further comprising:
facilitating transmission of first data via the first channel;
facilitating transmission of second data via the second channel; and
facilitating transmission of third data via the third channel.

15. The method of claim 14, further comprising:
retrieving the stored information from the database;
retrieving the stored updated information from the database; and
retrieving the stored further updated information from the database.

16. The method of claim 15, wherein the transmission of the first data, the second data, and the third data is based upon the stored information that is retrieved, the stored updated information that is retrieved, and the stored further updated information that is retrieved.

17. A method, comprising:
storing in a database information related to a reconfigurable optical add-drop multiplexer (ROADM) dense wavelength-division multiplexing (DWDM) system, resulting in stored information, wherein the stored information reserves a plurality of frequency bands, wherein each frequency band of the plurality of frequency bands comprises one or more frequency slots, wherein each frequency band of the plurality of frequency bands corresponds to a particular optical path of a plurality of optical paths in the ROADM DWDM system, wherein the stored information is indicative of an assigning of a first frequency to a first channel (CH1) that has a first one of the plurality of optical paths, wherein CH1 has a first required channel bandwidth, wherein the first frequency corresponds to a particular frequency band of one of the plurality of optical paths, and wherein guard bands had been added to both sides of CH1;
receiving a traffic demand for a second channel (CHx);
responsive to a first determination being that CHx has the optical path of CH1, assigning a second frequency to CHx with a second required channel bandwidth, wherein the second frequency corresponds to the particular frequency band of the optical path of CH1, wherein a guard band associated with CH1 that would have otherwise been between CH1 and CHx is removed and the bandwidth is instead used by CHx;
updating the database with updated information indicative of the assigning of the second frequency to CHx, resulting in stored updated information;
receiving another traffic demand for a third channel (CHy);
responsive to a second determination being that CHy does not have the optical path of CH1, assigning a third frequency to CHy with a third required channel bandwidth, wherein the third frequency corresponds to another frequency band that is not part of the optical path of CH1, and wherein a guard band is added to each side of CHy that has no adjacent channel; and
updating the database with additional updated information indicative of the assigning of the third frequency to CHy, resulting in stored additional updated information.

18. The method of claim 17, wherein each frequency slot corresponds to a respective channel.

19. The method of claim 17, wherein the database comprises additional information related to a previous traffic pattern, an anticipated demand in the future, a network topology of the ROADM DWDM system, an optical-signal-to-noise ratio (OSNR) of each optical path, a respective property of one or more transponders, a respective capability of one or more transponders, or any combination thereof.

20. The method of claim 19, wherein the assigning of the second frequency, the assigning of the third frequency, or any combination thereof is based upon the additional information.
